(19) United States
(12) Patent Application Publication
(10) Pub. No.: US 2018/0017946 A1
(43) Pub. Date: Jan. 18, 2018

(54) COMMUNICATION DEVICE, ELECTRONIC TIMEPIECE, TIME CORRECTING METHOD AND RECORDING MEDIUM

(71) Applicant: CASIO COMPUTER CO., LTD., Tokyo (JP)

(72) Inventors: Kazuho Kyou, Hamura-shi, Tokyo (JP); Makoto Nakagawa, Hamura-shi, Tokyo (JP); Hiroshi Iwamiya, Hamura-shi, Tokyo (JP); Takahiro Tomida, Hamura-shi, Tokyo (JP); Tsutomu Terazaki, Hamura-shi, Tokyo (JP); Ryo Okumura, Hamura-shi, Tokyo (JP); Toshihiro Takahashi, Hamura-shi, Tokyo (JP)

(21) Appl. No.: 15/627,608

(22) Filed: Jun. 20, 2017

(30) Foreign Application Priority Data
Jul. 14, 2016 (JP) 2016-138997

(51) Int. Cl. G04R 20/26; H04W 8/00; H04W 76/02; H04W 4/00; H04W 88/02

(52) U.S. Cl. CPC G04R 20/26; H04W 76/02; H04W 4/008; H04W 8/005; H04W 88/02

(57) ABSTRACT

According to an aspect of the present invention, a device capable of wireless communication includes a counter configured to count time, and a processor configured to perform control to send a notification signal for notification of existence of the device when the time of the counter reaches a predetermined first time, and correct the time of the counter to a predetermined second time upon receiving a connection request transmitted from other device in response to the notification signal.

### CROSS-REFERENCE TO RELATED APPLICATIONS

This application is based upon and claims the benefit of priority under 35 USC 119 of Japanese Patent Application No. 2016-138997 filed on Jul. 14, 2016, the entire disclosure of which is incorporated herein by reference in its entirety for all purposes.

### BACKGROUND OF THE INVENTION

### 1. Field of the Invention

The present invention relates to a communication device, an electronic timepiece, a time correcting method, and a computer readable recording medium for recording a program for executing the method thereon.

### 2. Description of the Related Art

Conventionally, there exist electronic devices capable of exchanging various kinds of information with other devices using a short-distance wireless communication protocol such as Bluetooth (Registered Trademark). Recently, Bluetooth 4.0 was developed as a new standard for solving the problem of high power consumption that the previous versions of Bluetooth had. Bluetooth version 4.0 and later versions are called Bluetooth Low Energy (“BLE”). Most wearable wireless communication devices such as smart bands, smart watches, smart glasses, etc., which have been recently launched, perform wireless communication using BLE.

By the short-range wireless communication, in particular, portable electronic devices can easily obtain information acquired and held by other electronic devices. Using this technology, interoperability between the electronic devices can be achieved, such as sending a notification to a smart watch when a smart phone receives an e-mail or transmitting user information acquired by a smart band to a smart phone.

For example, Japanese Patent Application Laid-Open Publication No. 2009-118403 published on May 28, 2009, discloses that detailed information of a LAN access service is exchanged between a first device (for example, a mobile phone) and a second device (for example, a watch-type terminal), which are capable of communicating by using a short-distance communication scheme, using an SDP(Service Discovery Protocol), the first device transmits time information to the second device after an RFCOMM connection and a service level connection are established between the two devices, and the second device performs time correction by setting its clock circuit according to the time information received from the first device.

According to the technology disclosed in Japanese Patent Application Laid-Open Publication No. 2009-118403, tiresome manipulations may be required depending on situations of an authentication procedure for the connection according to operating systems (OSs) because the time information is communicated after the connection between the two devices is established. On the other hand, in the case that a communication device is set such that the authentication procedure is not included in order to eliminate such tiresome manipulations, service discovery is performed after the device is connected to other device and communication for exchanging a large amount of information between the devices occurs for the service discovery. Therefore, a mass of data should be exchanged whenever time correction is performed periodically or when a predetermined event occurs. This increases power consumption.

An object of the present invention is to provide a communication device, an electronic timepiece, a time correcting method, and a computer readable recording medium for recording a program capable of performing time correction with low power consumption and without communicating a large amount of data.

### SUMMARY OF THE INVENTION

According to one aspect of the invention, a device capable of wireless communication includes a counter configured to count time, and a processor configured to perform control to send a notification signal for notification of existence of the device when the time of the counter reaches a predetermined first time, and correct the time of the counter to a predetermined second time upon receiving a connection request transmitted from other device in response to the notification signal.

According to another aspect of the invention, a device capable of wireless communication includes a counter configured to count time, and a processor configured to perform control to start detecting a notification signal for notification of existence of other device when the time of the counter reaches a predetermined first time, and, after receiving the notification signal, perform control to transmit a connection request to the other device when the time of the counter reaches a predetermined second time.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention will more sufficiently be understood by the following detailed description and the accompanying drawings, which are intended exclusively for explanation and do not limit the scope of the present invention.

Here:

FIG. 1 shows a system including a first device and a second device capable of wireless communication with the first device.

FIG. 2A is a block diagram showing a hardware configuration of a smart phone 1 which is the first device according to an embodiment of the invention.

FIG. 2B is a block diagram showing a hardware configuration of an electronic timepiece 2 which is the second device according to an embodiment of the invention.

FIG. 3 is a sequence diagram for showing a time correction process according to a first embodiment of the invention.

FIG. 4 shows an example of a structure of an advertising packet according to an embodiment of the invention.

FIG. 5 is a table for explaining the types of advertising packets.

FIG. 6 is a diagram for explaining an advertising time width Ta and a transmission interval Ti of an advertising packet.

FIG. 7A is a functional block diagram of the smart phone 1 for performing a time correction process according to an embodiment of the invention.

FIG. 7B is a functional block diagram of the electronic timepiece 2 for performing a time correction process according to an embodiment of the invention.

FIG. 8 is a flow chart showing an operation sequence of the smart phone 1 in the time correction process according to the first embodiment of the invention.

FIG. 9 is a flow chart showing an operation sequence of the electronic timepiece 2 in the time correction process according to the first embodiment of the invention.

FIG. 10 is a flow chart showing an operation sequence of the smart phone 1 in a time correction process according to a second embodiment of the invention.

FIG. 11 is a flow chart showing an operation sequence of the electronic timepiece 2 in the time correction process according to the second embodiment of the invention.

### DETAILED DESCRIPTION OF THE PREFERRED EMBODIMENT

In the present specification, the invention will be mainly described in connection with embodiments in which it has been applied to Bluetooth, in particular BLE, but its application field is not limited to Bluetooth. For example, the invention can be applied to different wireless communication technologies such as Body Area Network (“BAN”), Wi-Fi (Registered Trademark), and Wi-Fi Direct (Registered Trademark).

Hereinafter, embodiments of the present invention will be described with reference to the accompanying drawings. The scope of the invention is not intended to be limited to the illustrated examples.

### First Embodiment

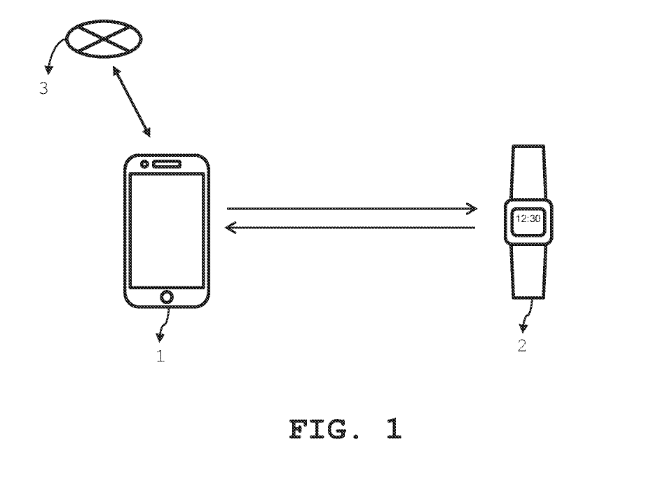

First, a first embodiment of the present application will be described. FIG. 1 shows a system including a first device 1 and a second device 2 which can be connected to and exchange data with the first device using a short distance wireless communication standard such as Bluetooth. FIG. 1 is common to the first embodiment and other embodiments described herein. The first device 1 to which the present invention is applied is a smart phone which is a kind of a mobile phone and is connected to a mobile communication network 3. However, the first device 1 is not limited to this embodiment and any type or any kind of device capable of short distance wireless communication and having a function of recording time can be the first device 1. The second device 2 to which the present invention is applied is an electronic timepiece which is a kind of a watch type terminal. However, the second device 2 is not limited to this embodiment and any type or any kind of device capable of short distance wireless communication and having a function of recording time can be the second device. For example, the second device 2 may be a digital camera, a healthcare appliance such as a digital body weight scale, or a wearable device such as a smart band. In the case that an event to be notified to a user occurs (for example, the first device receives an email or a call), the first device 1 can notify the second device 2 of the event via the short distance wireless communication. The second device 2 can transmit acquired data (for example, a travel distance, an altitude, or a pulse rate of the user) to the first device 1 via the short distance wireless communication.

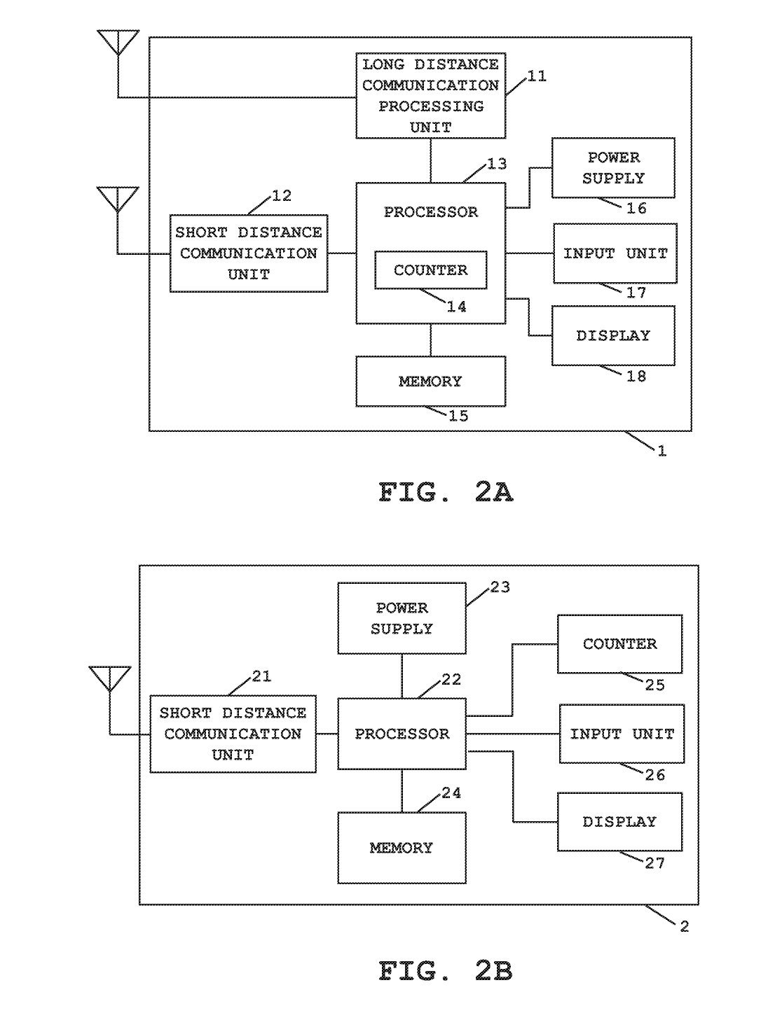

FIG. 2A is a block diagram showing a hardware configuration of the smart phone 1 which is the first device according to the embodiment of the invention. FIG. 2B is a block diagram showing a hardware configuration of the electronic timepiece 2 which is the second device according to the embodiment of the invention.

As shown in FIG. 2A, the smart phone 1 includes a long distance communication processing unit 11, a short distance communication unit 12, a processor 13, a memory 15, a power supply 16, an input unit 17, and a display 18. The processor 13 includes a counter 14. The long distance communication processing unit 11 makes the smart phone 1 serve as a mobile phone by communicating with a base station of a cellular network system such as 3G and LTE. The long distance communication processing unit 11 includes an amplifier for amplifying signals received or transmitted via an antenna, a transceiver, a digital baseband processor, a voice input circuit, or a playback circuit, but descriptions and drawings of these components are omitted because they are well-known. The counter 14 can hold accurate time information by acquiring accurate time data via the long distance communication processing unit 11 from the mobile communication network 3. As will be described later, the smart phone 1 notifies the electronic timepiece 2 of the time information held by the counter 14.

The short distance communication unit 12 enables the smart phone 1 to communicate with the electronic timepiece 2 which is the second device by a short distance wireless communication scheme such as Bluetooth or Wi-Fi. The short distance communication unit 12 includes a circuit for transforming an electromagnetic wave received via an antenna into an electric signal or transforming an electric signal input from the processor 13 into an electromagnetic wave. In the present embodiment, the short distance communication unit 12 supports BLE.

The processor 13 controls operations of the smart phone 1 and is an application processor, for example. While the processor 13 includes the counter 14 in the present embodiment, the counter 14 may be a separate element in different embodiments. The memory 15 is used to store computer program instructions executed by the processor 13, software such as firmware, data required by the processor 13, and/or data resulted from processing by the processor 13. The memory 15 includes one or more storage devices selected from a group including a RAM (Random Access Memory), a ROM (Read Only Memory), a flash memory, and a disk drive integrated into or removable from the smart phone 1. Alternatively, the memory 15 may be integrated into the processor 13.

The power supply 16 includes a battery and a power management unit (not shown in the drawing). The input unit 17 includes one or more keys, one or more switches, and/or a touch panel (not shown in the drawing). Various kinds of data are input according to manipulations of the input unit 17 by the user. The display 18 includes a display device such as an LCD or an OLED and a driving circuit (not shown in the drawing).

As shown in FIG. 2B, the electronic timepiece 2 includes a short distance communication unit 21, a processor 22, a power supply 23, a memory 24, a counter 25, an input unit 26, and a display 27. The short distance communication unit 21 enables the electronic timepiece 2 to communicate with the smart phone 1 which is the first device by the short distance wireless communication scheme such as Bluetooth or Wi-Fi. The short distance communication unit 21 includes a circuit for transforming an electromagnetic wave received via an antenna into an electric signal or transforming an electric signal input from the processor 22 into an electromagnetic wave. In the present embodiment, the short distance communication unit 21 supports BLE.

The processor 22 controls operations of the electronic timepiece 2. The power supply 23 includes a battery and a power management unit (not shown in the drawing). The memory 24 is used to store computer program instructions executed by the processor 22, software such as firmware, data required by the processor 22, and/or data resulted from processing by the processor 22. The memory 24 includes one or more storage devices selected from a group including a RAM (Random Access Memory), a ROM (Read Only Memory), a flash memory, or a disk drive integrated into or removable from the electronic timepiece 2. Alternatively, the memory 24 may be integrated into the processor 22.

The counter 25 includes a clock circuit for generating time signals, for example, from signals generated by a system clock or an oscillator (not shown in the drawing). The counter 25 generates time information by counting current time and outputs the generated time information to the processor 22. The counter 25 may be integrated into the processor 22. The input unit 26 includes one or more keys, one or more switches, and/or a touch panel (not shown in the drawing). Various kinds of data are input according to manipulations of the input unit 26 by the user. The display 27 includes a display device such as an LCD or an OLED and a driving circuit (not shown in the drawing) and displays information such as the current time.

The electronic timepiece 2 normally displays the current time, which is being counted by the counter 25, using the display 27. As will be described later, in the case that the electronic timepiece 2 receives data indicating current time of the counter 14 from the smart phone 1 via the short distance communication unit 21, time of the electronic timepiece 2 is synchronized with that of the smart phone 1 by setting the counter 25 to the time indicated by the received data.

The system shown in FIG. 1, and the smart phone 1 and the electronic timepiece 2 shown in FIGS. 2A and 2B, respectively, are merely examples and do not limit the scope of systems or devices capable of implementing time correction processes described herein.

Next, operations for time correction of the smart phone 1 and the electronic timepiece 2 are described. The operations are performed to adjust time of the electronic timepiece 2 to that of the smart phone 1. In the present application, both of the smart phone 1 and the electronic timepiece 2 support Bluetooth, in particular, BLE. According to the Bluetooth specification (see Bluetooth Specification Version 4.2 (2014)), packets of the BLE Protocol are classified into two kinds: advertising packets and data packets. A device uses an advertising packet to notify other device of its existence and request connection to the other device. The advertising packet is transmitted and received via an advertise channel. On the other hand, a data packet is exchanged after a connection between the two devices is established.

Further, according to the BLE Protocol, a plurality of devices communicates in a broadcast mode or a connection mode. In the broadcast mode (also referred to as an “advertise mode”), a device periodically sends advertise signals to all nearby devices without specifying one of them. The specification defines two roles, one of which a device plays in the broadcast mode: Broadcaster and Observer. A broadcaster (also referred to as an “advertiser”) periodically sends Non-Connectable advertising packets regardless of whether or not other devices are capable of receiving signals. An observer is a device which performs scanning periodically to receive the Non-Connectable advertising packet sent from the broadcaster. The broadcast mode is used mainly in the case that one device informs other device(s) of its existence or in the case that a small amount of data (smaller than 31 byte) needs to be transmitted.

In the case that bidirectional data communication between two devices is required or one device should transmit a large amount of data which cannot be transmitted by an advertising packet to the other device, the two devices communicate in the connection mode. The specification defines two roles, one of which a device plays in the connection mode: Central (also referred to as a “master”) and Peripheral (also referred to as a “slave”). A Central device periodically scans for a Connectable advertising packet sent from other device(s) and requests connection to a proper one of the other device(s). A Peripheral device periodically sends Connectable advertising packets in order to form a connection to other device and form a connection to a Central device by receiving Connection Request sent from the Central device which received the Connectable advertising packet.

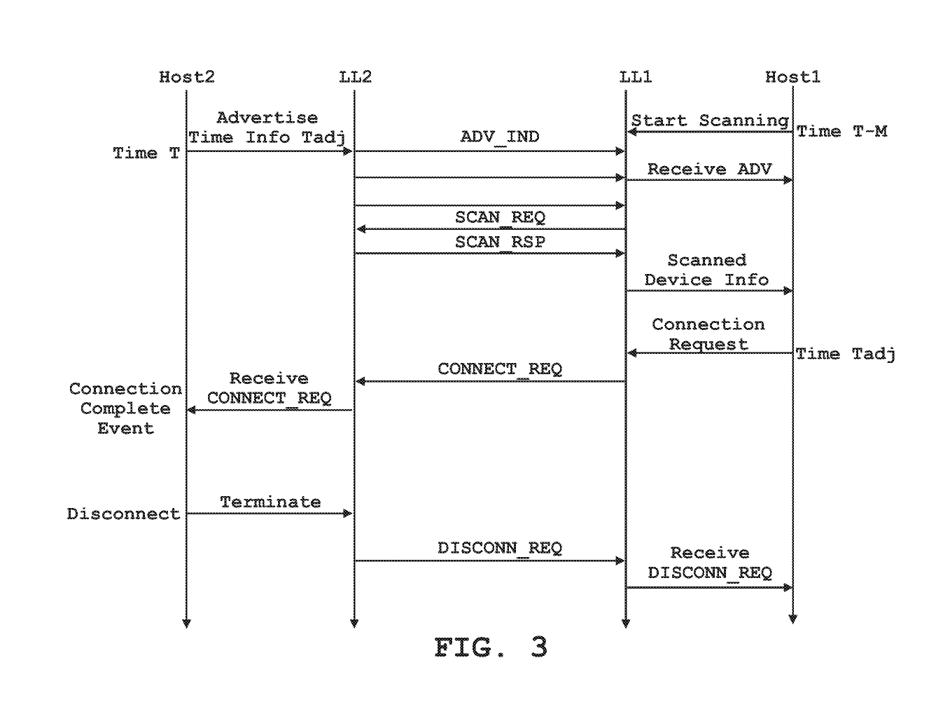

FIG. 3 is a sequence diagram for showing a time correction process according to the embodiment. FIG. 3 shows interaction between the smart phone 1 and the electronic timepiece 2. Host1 and LL1 are a host and a link layer of the smart phone 1, respectively. Host2 and LL2 are a host and a link layer of the electronic timepiece 2, respectively. In the present embodiment, the smart phone 1 serves as the master and the electronic timepiece 2 serves as the slave. In FIG. 3, the time T is starting time of the time correction process set previously. For example, the time T is 12:00 AM every day. In the present embodiment, the period of the starting time is one day, that is, 24 hours. According to embodiments, the period of the starting time can be set to be longer or shorter than one day, or set irregularly. The starting time should be set to be the same in both of the smart phone 1 and the electronic timepiece 2. The starting time may be preset when the devices are designed or set by the user. Alternately, the starting time may be updated when a program controlling the time correction process is updated if necessary.

When the time of the counter 14 of the smart phone 1 is T−M, the processor 13 controls the short distance communication unit 12 to start scanning. Scanning is an operation to detect an advertising packet (or, a notification signal) sent from the electronic timepiece 2. In the present embodiment, a time width during which the scanning is performed is set to Ts. The advertising packet is a type of packet defined in the Bluetooth Protocol and is used in the case that one device wants to notify nearby device(s) of its existence or to transmit a small amount of data to the nearby device(s). Here, M is a margin which is intended to securely receive communication from the electronic timepiece 2. Since the smart phone 1 starts scanning M earlier than the time T (i.e. the time T−M), a possibility that the smart phone 1 misses the first packet sent from the electronic timepiece 2 is reduced, even in the case that there is a difference between the time of the smart phone 1 and the time of the electronic timepiece 2 and the electronic timepiece 2 sends a packet earlier than the time T of the smart phone 1. Thus, the smart phone 1 can reliably receive the packet sent from the electronic timepiece 2. In the present embodiment, since the time correction process is performed once every 24 hours, it is desirable to set M such that M satisfies M>Te where Te is a time error of the electronic timepiece 2 assumed for 24 hours which is one period. Further, since there is a possibility that a reception error of the advertising packet may occur due to radio wave interference or the like, the smart phone 1 continues scanning for the time width Ts.

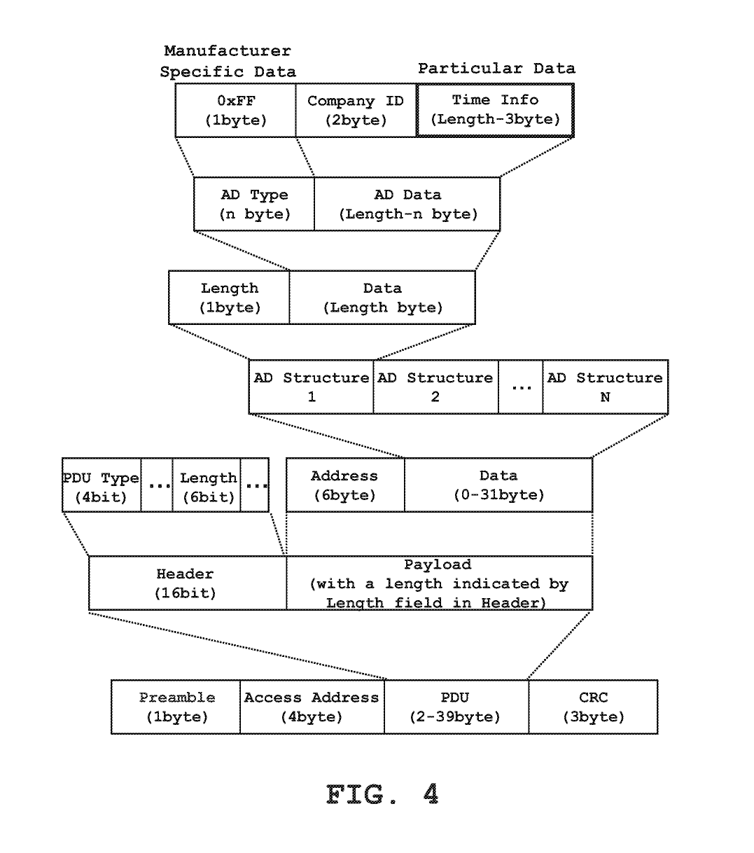

The electronic timepiece 2 generates an advertising packet in which predetermined time information Tadj is stored and sends the advertising packet (or, the notification signal) when the time of the counter 25 is T. The time information Tadj indicates time at which the smart phone 1, which is a communication partner of the electronic timepiece 2, is required to send the connection request and is determined based on the frequency of performing the time correction process and the time error of the electronic timepiece 2. For example, in the case that the time correction process is performed once every day and the time error of the electronic timepiece 2 is ±N seconds for one day, Tadj is determined to satisfy Tadj>T+N. The time information Tadj is stored in a data field of a payload of a PDU of the advertising packet, as shown in FIG. 4. The structure of the advertising packet will be described later. The electronic time piece 2 repeats sending the advertising packet in which Tadj is stored for a predetermined time width Ta at a time interval Ti and ends the advertisement when Ta elapses. Since there is a possibility that a reception error of the advertising packet may occur due to radio wave interference or the like, the electronic timepiece 2 repeats advertising for the time width Ta at the interval Ti.

In the case that the smart phone 1 receives the advertising packet sent from the electronic timepiece 2 within the time width Ts, it extracts the time information Tadj from the received advertising packet. Then, the smart phone 1 transmits a scan request (SCAN_REQ PDU) to request additional information (for example, device information such as a device address or device name, and/or services provided by the advertiser) to the electronic timepiece 2. In the case that the electronic timepiece 2 can process the scan request, it transmits a scan response (SCAN_RSP PDU) to the smart phone 1 via the same advertising physical channel. The scan response includes the device address of the electronic timepiece 2 and scan response data. The smart phone 1 can determine whether or not a connection to the electronic timepiece 2 is possible according to the information included in the scan response data.

In the case that the smart phone 1 does not receive the advertising packet even after performing scanning for the time width Ts, the processor 13 controls the display unit 18 to display a message indicating that an error has occurred. By this, the user can be requested to perform a manual operation for time correction, for example.

The smart phone 1 waits until the time of the counter 14 reaches the time indicated by the time information Tadj extracted from the advertising packet. When the time of the counter 14 reaches Tadj, the smart phone 1 transmits the connection request (CONNECT_REQ) to the electronic timepiece 2 which transmitted the advertising packet and is temporarily enabled to process data communication. According to the Bluetooth protocol, a timing at which the smart phone 1 transmits the connection request is 150 microseconds (μs) after the end of the advertisement. A payload included in the packet of the connection request contains a device address of the smart phone 1 which is the initiator, the address of the electronic timepiece 2 which is the advertiser, and connection setup parameter(s). A connection complete event occurs in the case that the electronic timepiece 2 receives the connection request. Thus, the connection between the smart phone 1 and the electronic timepiece 2 is established temporarily and the electronic timepiece 2 is enabled to process the data communication. Further, in the case of receiving the connection request from the smart phone 1, the electronic timepiece 2 corrects the time of the counter 25 to Tadj when the connection complete event occurs, and immediately transmits a disconnect request (DISCONN_REQ) to the smart phone 1 to terminate the connection. The smart phone 1 terminates data communication processing upon receiving the disconnect request. While the disconnect request is transmitted after correcting the time in the present embodiment, the disconnect request may be transmitted immediately after receiving the connection request in other embodiments. Further, according to embodiments, the electronic timepiece 2 does not transmit the disconnect request.

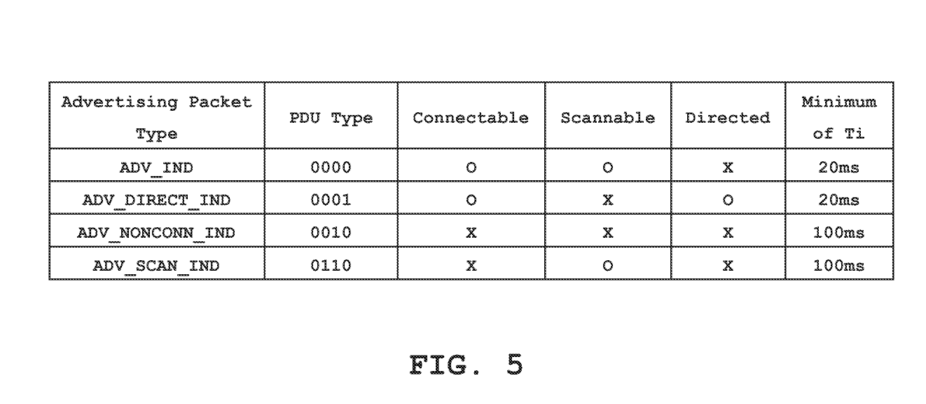

FIG. 4 shows an embodiment of the structure of the advertising packet sent from the electronic timepiece 2 to the smart phone 1. FIG. 5 is a table for explaining the types of advertising packets. As shown in FIG. 5, there are four types of advertising packets used for Bluetooth communication. A value set in a PDU Type field of a header of the PDU of a packet indicates the type of the packet. ADV_IND is used in connectable undirected advertising events. The connectable undirected advertising event type allows simple information inquiry (that is, scannable). The simple information inquiry means a procedure in which the device performing scanning (referred to as a “scanner”) transmits to the device performing advertising (“advertiser”) the scan request (SCAN_REQ PDU) to request additional information about the advertiser (for example, device information or services provided by the advertiser) before connection. ADV_DIRECT_IND is used in connectable directed advertising events. ADV_DIRECT_IND has no data part in which advertising data can be stored. Therefore, in the case that the advertiser's data is required to be transmitted by advertisement, ADV_DIRECT_IND cannot be used. ADV_NONCONN_IND is used in non-connectable undirected advertising events. ADV_SCAN_IND is used in scannable undirected advertising events. The scannable undirected advertising event type allows the simple information inquiry (that is, only the simple information inquiry is possible for any device).

Since the present embodiment is based on the premise that the time information Tadj is stored in the advertising packet and the electronic timepiece 2 receives the connection request from the smart phone 1, the ADV_IND type advertising packet is used. FIG. 4 shows the structure of the ADV_IND type advertising packet. The PDU of the ADV_IND type advertising packet includes the header and the payload and the PDU Type field of the header is set to 0000. The payload of the packet includes an Address field and a Data field. The Address field contains a public or random device address of the advertiser and the Data field contains advertising data from the host of the advertiser. An AD Type field of the Data field contains manufacturer-specific data. In the present embodiment, the AD Type field is set to Service Data UUID (Universally Unique IDentifier) indicating that the present advertising packet is intended for time correction. In the example of FIG. 4, the AD Type field is set to 0xFF. A Bluetooth terminal can determine what data an adverting packet received from a different terminal contains by processing the advertising packet and detecting the value of the AD Type field included in the advertising packet. The time information Tadj is stored in the AD Data field. The time data may be represented by a counter value at a specific interval (for example, 50 ms) from a specific date, and may also include information on a time zone. The information of the time zone has a format of ±XX (a difference between the standard time of the area and GMT), for example.

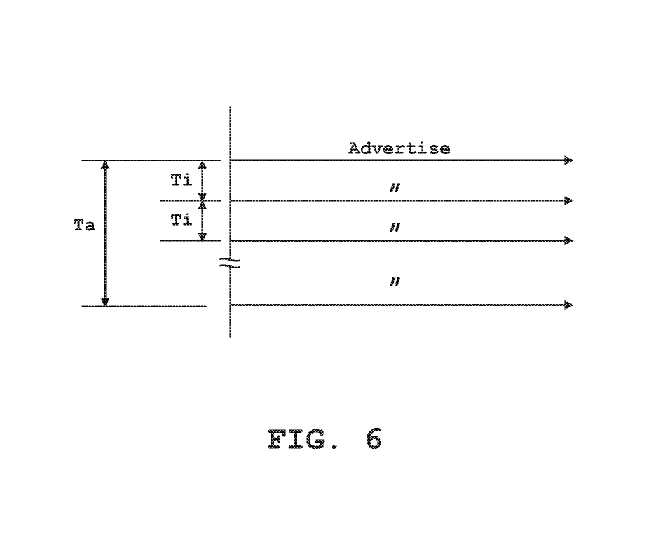

As shown in FIGS. 5 and 6, the Bluetooth specification specifies a possible minimum value of an advertising interval (Ti), that is, a time interval at which an advertising packet is repeatedly transmitted, for each type of the advertising packet. As shown in FIG. 6, a device performing advertisement sends the advertising packet at the interval of Ti during the predetermined time width Ta. Ti can be set within the range of 20 milliseconds to 10.24 seconds in 0.625 millisecond intervals. It is possible to set a minimum value of Ti to 20 milliseconds for each of ADV_IND and ADV_DIRECT_IND, and to 100 milliseconds for each of ADV_NONCONN_IND and ADV_SCAN_IND.

Even in the case that the device performing scanning cannot receive one (that is, the first) or more advertising packets, it can receive the advertising packet sent later than the one or more packets within a short time if the time interval Ti at which the advertising packet is repetitively transmitted is short. Such a short time interval Ti can also reduce the time width Ta. Further, since the timing at which the smart phone 1 transmits the connection request is immediately after the end of the advertisement (exactly, 150 μs after the end of the advertisement) as described above, the timing may be delayed by up to Ti with respect to Tadj. Therefore, it is preferable that Ti is short in order to minimize the error between Tadj and the time at which the connection request is transmitted.

As described above, the electronic timepiece 2 transmits the time information Tadj showing a point of time at which it desires to receive the connection request using the advertising packet and extracts the time information Tadj to perform time correction immediately upon receiving the connection request from the smart phone 1. Then, the electronic timepiece 2 immediately transmits the disconnect request to the smart phone 1. In other words, the electronic timepiece 2 can recognize that a timing of receiving the connection request is the time indicated by the time information. By this, the smart phone 1 can inform the electronic timepiece 2 of the time information without performing data communication after the connection is established between the smart phone 1 and the electronic timepiece 2. Conventionally, a large amount of information is communicated in order to exchange service information, characteristic information, and the like, after a connection is established between two devices even if there is no actual data to be exchanged between them. According to the present embodiment, it is possible to reduce power consumption compared to the conventional technology because communication for exchanging such a large amount of information does not occur.

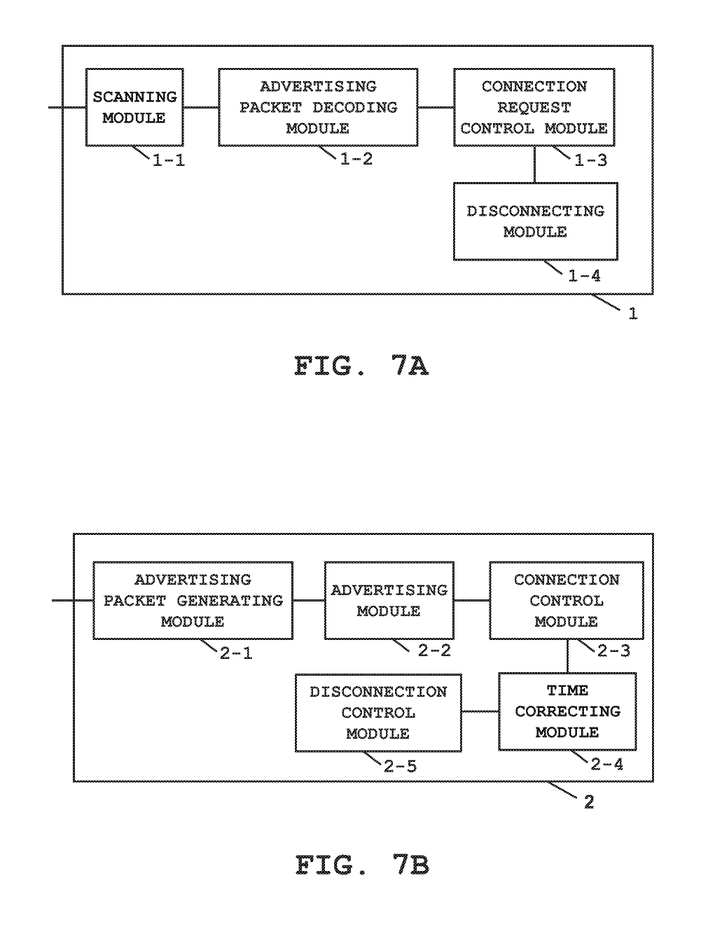

FIG. 7A is a functional block diagram of the smart phone 1 for performing the time correction process according to the embodiment. FIG. 7B is a functional block diagram of the electronic timepiece 2 for performing the time correction process according to the embodiment.

As shown in FIG. 7A, the smart phone 1 includes a scanning module 1-1, an advertising packet decoding module 1-2, a connection request control module 1-3, and a disconnecting module 1-4. The modules 1-1 to 1-4 can be configured by software, hardware, or combinations thereof. The scanning module 1-1 scans for an advertising packet for the predetermined time width Ts. As described above, in the present embodiment, the scanning module 1-1 starts scanning when the time of the smart phone 1 reaches T−M. In the case that the advertising packet in which the time information Tadj is stored is not received within the scan time width Ts, the smart phone 1 notifies the user of the error message. The advertising packet decoding module 1-2 decodes the advertising packet received during the scan period Ts and extracts data stored in the advertising packet. In the present embodiment, the advertising packet decoding module 1-2 extracts the time information Tadj stored in the advertising packet received from the electronic timepiece 2.

The connection request control module 1-3 generates the connection request packet for requesting a connection to a proper one of one or more other communication devices sending the advertising packets and transmits it to the other communication device. In the present embodiment, when the time of the smart phone 1 reaches the time indicated by the time information Tadj contained in the advertising packet received by the scanning module 1-1, the connection request control module 1-3 transmits the connection request packet to the electronic timepiece 2. In the case that the smart phone 1 receives the disconnect request from other communication device connected to the smart phone 1, the disconnecting module 1-4 disconnects the connection between the smart phone 1 and the other communication device. In the present embodiment, the disconnecting module 1-4 disconnects the connection between the smart phone 1 and the electronic timepiece 2 upon receiving the disconnect request (DISCONN_REQ) from the electronic timepiece 2.

As shown in FIG. 7B, the electronic timepiece 2 includes an advertising packet generating module 2-1, an advertising module 2-2, a connection control module 2-3, a time correcting module 2-4, and a disconnection control module 2-5. The advertising packet generating module 2-1 generates an advertising packet. As described above, in the present embodiment, the advertising packet generating module 2-1 acquires the time information Tadj determined based on the time T and the time error assumed for the period of the time correction and generates the advertising packet containing a data part in which the time information Tadj is stored. The advertising module 2-2 sends the advertising packet. In the present embodiment, the advertising module 2-2 starts to send the advertising packet in which the time information Tadj is stored when the time of the electronic timepiece 2 reaches T. The advertising is repeated for the time width of Ta at the interval of Ti.

The connection control module 2-3 establishes a connection to other communication device in the case that the connection request packet is received from the other communication device. In the present embodiment, the connection control module 2-3 enables the electronic timepiece 2 to perform data communication with the smart phone 1 in the case that the connection request is received from the smart phone 1. The time correcting module 2-4 corrects the time of the clock included in the electronic timepiece 2 (i.e. the counter 25) to a predetermined time. In the present embodiment, when the electronic timepiece 2 receives the connection request from the smart phone 1 and the connection complete event occurs, the time correcting module 2-4 corrects the time of the electronic timepiece 2 to Tadj acquired by the advertising packet generating module 2-1. By this, it is possible to synchronize the time of the electronic timepiece 2 with the time of the smart phone 1. The disconnection control module 2-5 generates the disconnect request to disconnect a connection established between the electronic timepiece 2 and the other communication device, transmits it to the other communication device, and terminates data communication with the other communication device. In the present embodiment, the disconnection control module 2-5 transmits the disconnect request to the smart phone 1 immediately after the time correcting module 2-4 corrects the time of the electronic timepiece 2 and terminates the data communication with the smart phone 1.

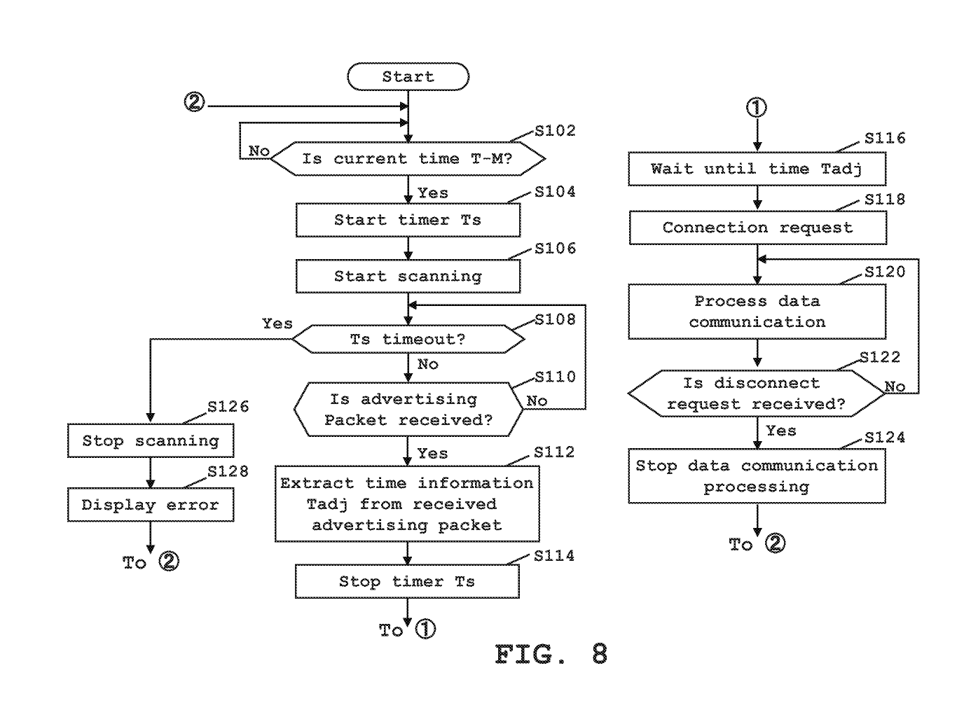

FIG. 8 is a flow chart showing an operation sequence of the smart phone 1 in the time correction process according to the present embodiment of the invention. First, the processor 13 determines whether or not the time of the counter 14 is T−M (Step S102). In the case that the time of the counter 14 is not T−M (Step S102: No), the smart phone 1 does not proceed with the time correction process. In the case that the time of the counter 14 is T−M (Step S102: Yes), the processor 13 starts a timer to check whether or not the predetermined time Ts has elapsed (Step S104), and starts scanning (Step S106). Ts is the time width during which the smart phone 1 performs scanning in order to receive the advertising packet.

In the case that the timer does not reach Ts, that is, before a timeout occurs (Step S108: No), the processor 13 checks whether or not the advertising packet is received (Step S110). In the case that the advertising packet is not received (Step S110: No), the process returns to Step S108.

In the case that the advertising packet is received before the timeout occurs (Step S110: Yes), the time information Tadj is extracted from the data part of the received advertising packet (Step S112). Then, the timer for checking Ts is stopped (Step S114). After waiting until the time of the counter 14 reaches Tadj (Step S116), the processor 13 performs control to transmit the connection request to the electronic timepiece 2 at the time Tadj (Step S118). By this, the smart phone 1 is enabled to process data communication with the electronic timepiece 2 (Step S120). Then, the processor 13 determines whether or not the disconnect request is received (Step S122). In the case that the disconnect request is received from the electronic timepiece 2 (Step S122: Yes), the processor 13 stops data communication processing (Step S124). On the other hand, in the case that the disconnect request is not received from the electronic timepiece 2 (Step S122: No), the process returns to Step S120 and continues the data communication processing.

In the case that the timer reaches Ts in a state where the advertising packet is not received (Step S108: Yes), the scanning is stopped (Step S126). In other words, in the case that the advertising packet is not received even if scanning is performed for the time width Ts, the display 18 displays a message indicating that an error has occurred because the time correction process cannot proceed (Step S128). Then, the process returns to Step S102.

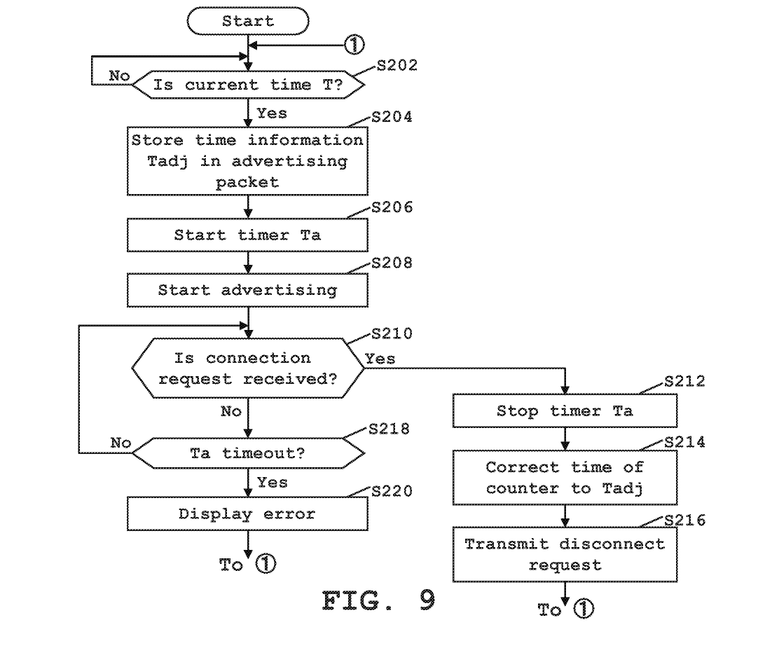

FIG. 9 is a flow chart showing an operation sequence of the electronic timepiece 2 in the time correction process according to the present embodiment of the invention. First, the processor 22 determines whether or not the time of the counter 25 is T (Step S202). In the case that the time of the counter 25 is not T (Step S202: No), the electronic timepiece 2 does not proceed with the time correction process. In the case that the time of the counter 25 reaches T (Step S202: Yes), the processor 22 stores the time information Tadj in an advertising packet (Step S204). As described above, the time information Tadj indicates the point of time at which the smart phone 1 is required to transmit the connection request and is determined based on the frequency of performing the time correction process and the time error of the electronic timepiece 2. Further, the time information Tadj is stored in the payload of the PDU of the ADV_IND type advertising packet (see FIG. 4).

The processor 22 starts a timer to check whether or not the predetermined time Ta has elapsed (Step S206), and starts advertising (Step S208). Then, the processor 22 determines whether or not the connection request is received from the smart phone 1 (Step S210). In the case that the connection request is received before the time Ta has elapsed, that is, before a timeout occurs (Step S210: Yes), the timer for checking Ta is stopped (Step S212). Then, the processor 22 corrects the time of the counter 25 to Tadj (Step S214). After that, the disconnect request is immediately transmitted to the smart phone 1 (Step S216).

On the other hand, in the case that the connection request is not received (Step S210: No), the processor 22 determines whether or not the timer reaches Ta (Step S218). In the case that the timer does not reach Ta, that is, the timeout does not occur (Step S218: No), the process returns to Step S210. In the case that the timer reaches Ta, that is, the timeout occurs, in a state where the connection request is not received (Step S218: Yes), the display 27 displays a message indicating that an error has occurred because the time correction process cannot proceed (Step S220). Then, the process returns to Step S202. In other words, the processor 22 controls the display 27 to display the error message in order to request the user to perform a manual operation for time correction in the case that the connection request is not received even after the advertising packet is repeatedly transmitted for the time width Ta.

The algorithms of FIG. 8 and FIG. 9 according to the first embodiment can be implemented by hardware, software, or a combination thereof. In the case that the algorithm shown in FIG. 8 is implemented by software, a program constituting the software is installed in the smart phone 1 from a network or a storage medium. For example, the program can be downloaded and installed from a server to the smart phone 1 via the Internet. A medium for recording the program may be the memory 15 (or another storage device included in the smart phone 1) or a removable medium (not shown in the drawings) detachable from the smart phone 1. In this case, the processor 13 performs a series of steps required for the time correction process according to the program, i.e. the algorithm shown in FIG. 8. In the case that the algorithm shown in FIG. 9 is implemented by software, a program constituting the software is installed in the electronic timepiece 2 from a network or a storage medium. A medium for recording the program may be the memory 24 (or another storage device included in the electronic timepiece 2) or a removable medium (not shown in the drawings) detachable from the electronic timepiece 2. In this case, the processor 22 performs a series of steps required for the time correction process according to the program, i.e. the algorithm shown in FIG. 9.

According to the time correction process of the present embodiment, the electronic timepiece 2 transmits the time information indicating the timing of time correction by advertisement, the smart phone 1 transmits the connection request in accordance with the timing indicated by the time information, and the electronic timepiece 2 performs time correction by receiving the connection request, as described above. Since the electronic timepiece 2 transmits the time information indicating the timing of time correction by advertisement to the smart phone 1 and the smart phone 1 receiving the time information transmits the connection request in accordance with the timing indicated by the time information, the electronic timepiece 2 can recognize an accurate timing of time correction by receiving the connection request. Further, since the electronic timepiece 2 transmits the disconnect request to the smart phone 1 immediately after receiving the connection request, data communication that is normally performed after connection establishment is not performed in the present embodiment.

Conventionally, after a connection between two devices is established, information on a service available in one of the devices and characteristics of the service (protocol information, authentication information, profile data, or the like) is exchanged between the two devices using the SDP (Service Discovery Protocol). Therefore, communication of a large amount of data occurs and power consumption increases. On the other hand, according to the present embodiment of the invention, since the electronic timepiece 2 transmits the disconnect request before data communication using the SDP occurs, it is possible to correct the time of the electronic timepiece 2 while suppressing power consumption for the data communication as much as possible. According to the embodiment, a total amount of data exchanged between the smart phone 1 and the electronic timepiece 2 is reduced to a level of 1/20 to 1/10 compared to the conventional method of continuing data communication after the connection between the devices is established. Therefore, the power consumption can be significantly reduced.

### Second Embodiment

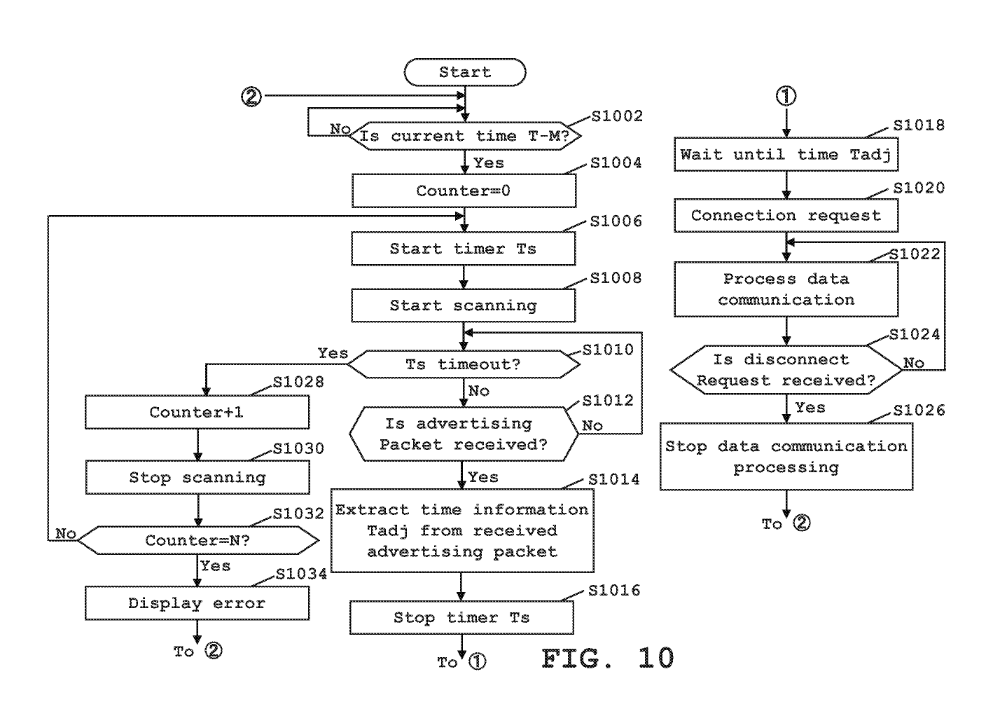

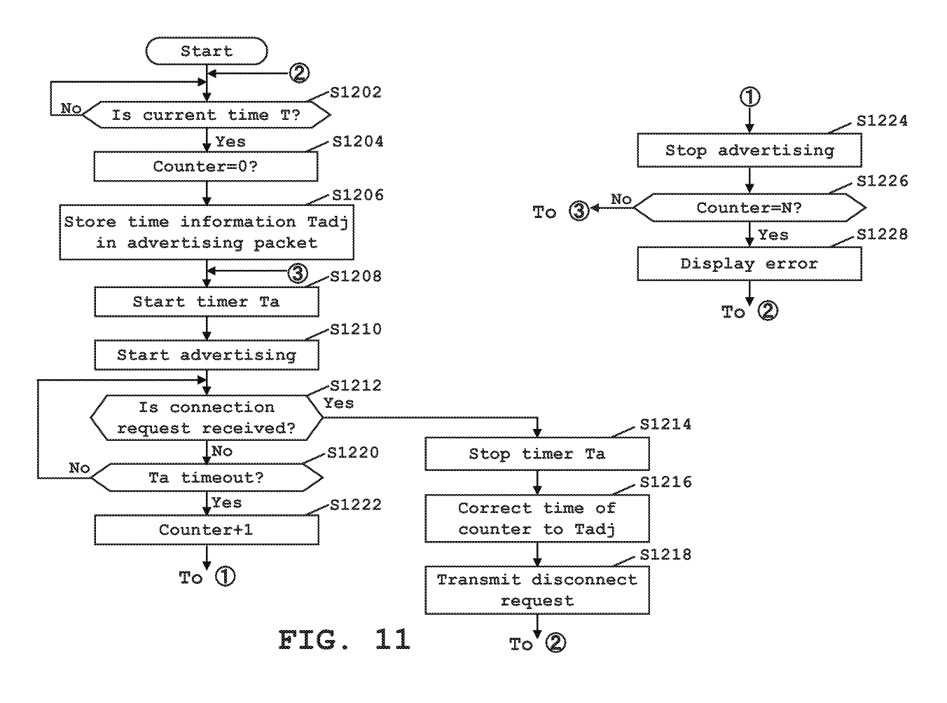

Hereinafter, a second embodiment of the present invention will be described referring to FIGS. 10 and 11. In the first embodiment, the smart phone 1 ends the time correction process and displays the error message in the case that it does not receive the advertising packet within the time width Ts and the electronic timepiece 2 ends the time correction process and displays the error message in the case that it does not receive the connection request within the time width Ta.

The second embodiment is intended to cope with a case where the time error of the electronic timepiece 2 is relatively large. FIG. 10 is a flow chart showing an operation sequence of the smart phone 1 in a time correction process according to the second embodiment of the invention. A detailed description of steps of FIG. 10 which are similar to those of FIG. 8 will be omitted.

First, the processor 13 determines whether or not the time of the counter 14 is T−M (Step S1002). In the case that the time of the counter 14 is not T−M (Step S1002: No), the smart phone 1 does not proceed with the time correction process. In the case that the time of the counter 14 is T−M (Step S1002: Yes), the processor 13 sets a counter to zero (0) (Step S1004). Further, the processor 13 starts the timer to check whether or not the predetermined time Ts has elapsed (Step S1006), and starts scanning (Step S1008). In the case that the timer does not reach Ts, that is, before a timeout occurs (Step S1010: No), the processor 13 checks whether or not the advertising packet is received (Step S1012). In the case that the advertising packet is not received (Step S1012: No), the process returns to Step S1010.

In the case that the advertising packet is received before the timeout occurs (Step S1012: Yes), the time information Tadj is extracted from the received advertising packet (Step S1014). Then, the timer for checking Ts is stopped (Step S1016). After waiting until the time of the counter 14 reaches Tadj (Step S1018), the processor 13 transmits the connection request to the electronic timepiece 2 at the time Tadj (Step S1020). By this, the smart phone 1 is enabled to process data communication with the electronic timepiece 2 (Step S1022). Then, the processor 13 determines whether or not the disconnect request is received (Step S1024). In the case that the disconnect request is received from the electronic timepiece 2 (Step S1024: Yes), the processor 13 stops data communication processing (Step S1026). On the other hand, in the case that the disconnect request is not received from the electronic timepiece 2 (Step S1024: No), the process returns to Step S1022 and continues the data communication processing.

In the case that the timer reaches Ts in a state where the advertising packet is not received (Step S1010: Yes), the value of the counter is incremented by one (1) (Step S1028) and the scanning is stopped (Step S1030). Then, the processor 13 determines whether or not the value of the counter reaches a predetermined value N (Step S1032). In the case that the value of the counter reaches N (Step S1032: Yes), the display 18 displays a message that an error has occurred because the time correction process cannot proceed (Step S1034). After that, the process returns to Step S1002. On the other hand, in the case that the value of the counter does not reach N (Step S1032: No), the process returns to Step S1006.

FIG. 11 is a flow chart showing an operation sequence of the electronic timepiece 2 in the time correction process according to the second embodiment of the invention. A detailed description of steps of FIG. 11 which are similar to those of FIG. 9 will be omitted. First, the processor 22 determines whether or not the time of the counter 25 is T (Step S1202). In the case that the time of the counter 25 is not T (Step S1202: No), the electronic timepiece 2 does not proceed with the time correction process. In the case that the time of the counter 25 reaches T (Step S1202: Yes), the processor 22 sets a counter to zero (0) (Step S1204). Further, the processor 22 stores the time information Tadj in an advertising packet (Step S1206). The processor 22 starts the timer to check whether or not the predetermined time Ta has elapsed (Step S1208), and starts advertising (Step S1210). Then, the processor 22 determines whether or not the connection request is received from the smart phone 1 (Step S1212). In the case that the connection request is received before the time Ta has elapsed, that is, before a timeout occurs (Step S1212: Yes), the timer for checking Ta is stopped (Step S1214). Then, the processor 22 corrects the time of the counter 25 to Tadj (Step S1216). After that, the disconnect request is immediately transmitted to the smart phone 1 (Step S1218).

On the other hand, in the case that the connection request is not received (Step S1212: No), the processor 22 determines whether or not the timer reaches Ta (Step S1220). In the case that the timer does not reach Ta, that is, the timeout does not occur (Step S1220: No), the process returns to Step S1212. In the case that the timer reaches Ta, that is, the timeout occurs, in a state where the connection request is not received (Step S1220: Yes), the value of the counter is incremented by one (1) (Step S1222) and the advertising is stopped (Step S1224). Then, the processor 22 determines whether or not the value of the counter reaches a predetermined value N (Step S1226). In the case that the value of the counter reaches N (Step S1226: Yes), the display 27 displays a message that an error has occurred because the time correction process cannot proceed (Step S1228). After that, the process returns to Step S1202. On the other hand, in the case that the value of the counter does not reach N (Step S1226: No), the process returns to Step S1208.

As described above, in the case that the smart phone 1 fails to detect the advertising packet within a predetermined period of time, the smart phone 1 stops scanning and increases the value of the counter, and then restarts scanning. Further, in the case that the electronic timepiece 2 fails to detect the connection request within a predetermined period of time, the electronic timepiece 2 stops advertising and increases the value of the counter, and then restarts advertising. In the case that the advertising packet and/or the connection request is not received even after repeating the above operations a predetermined number of times (N in the present embodiment), the smart phone 1 and/or the electronic timepiece 2 displays a message indicating that an error has occurred. By this, the user can be requested to perform a manual operation for time correction, for example. According to the second embodiment, the time correction process can be performed automatically without manipulations of the user by repeating scanning and advertising a predetermined number of times, even in the case that the error between the time of the smart phone 1 and the electronic timepiece 2 is relatively large.

### Third Embodiment

Since the first and the second embodiments are based on the premise that the time information Tadj is stored in the advertising packet and the electronic timepiece 2 receives the connection request from the smart phone 1, the ADV_IND type advertising packet is used. On the other hand, in a third embodiment, the smart phone 1 and the electronic timepiece 2 are configured such that time correction is performed at time Tcor of the smart phone 1. Further, no time information is stored in advertising packets.

In the third embodiment, the electronic timepiece 2 starts advertising at the timing which is earlier than Tcor by a time margin Me determined in consideration of the time error assumed for the frequency of the time correction. In other words, the electronic timepiece 2 starts advertising when the time of the clock included therein (i.e. the counter 25) reaches Tcor-Me. Further, the smart phone 1 transmits the connection request to the electronic timepiece 2 at the time Tcor set previously. By correcting the time of the clock included therein (i.e. the counter 25) to Tcor upon receiving the connection request from the smart phone 1, the time of the electronic timepiece 2 can be synchronized with the time of the smart phone 1. Since no time information is stored in the advertising packet in the present embodiment, the ADV_DIRECT_IND type advertising packet can also be used.

The present invention has been described with respect to specific embodiments in which it has been applied to Bluetooth, in particular BLE, but its application field is not limited to Bluetooth. For example, the invention can be applied to different wireless communication technologies such as BAN (Body Area Network), Wi-Fi (Registered Trademark), and Wi-Fi Direct (Registered Trademark).

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation. These modifications and embodiments fall within the scope and the spirit of the invention described in this specification and within the scope of the invention as defined in the appended claims and equivalents thereof.

What is claimed is:

1. A device capable of wireless communication comprising:
a counter configured to count time; and
a processor configured to perform control to send a notification signal for notification of existence of the device when the time of the counter reaches a predetermined first time, and correct the time of the counter to a predetermined second time upon receiving a connection request transmitted from other device in response to the notification signal.

2. The device of claim 1, wherein the processor is further configured to include information on the second time indicating a timing at which the other device transmits the connection request in the notification signal.

3. The device of claim 1, wherein the processor is further configured to perform control to transmit a disconnect request to the other device immediately after correcting the time of the counter to the second time.

4. The device of claim 1, wherein the processor is further configured to perform control to transmit a disconnect request to the other device immediately after receiving the connection request.

5. The device of claim 1, wherein the processor is further configured to perform control to send the notification signal repeatedly for a predetermined period of time.

6. The device of claim 1, wherein the processor is further configured to perform control to stop sending the notification signal in the case that the connection request is not received within a predetermined period of time after starting to send the notification signal.

7. The device of claim 1 further comprising a display unit,
wherein the processor is further configured to control the display unit to display a message indicating that time correction cannot be performed in the case that the connection request is not received within a predetermined period of time after starting to send the notification signal.

8. The device of claim 1, wherein the processor is further configured to perform control to send the notification signal repeatedly a predetermined number of times for a predetermined period of time in the case that the connection request is not received within the predetermined period of time after starting to send the notification signal.

9. The device of claim 1, wherein the second time is determined based on the predetermined first time.

10. The device of claim 1, wherein the processor is further configured to determine the second time based on the predetermined first time.

11. The device of claim 1, wherein the device communicates with the other device via Bluetooth, and the notification signal is an advertising signal.

12. The device of claim 1, wherein the device communicates with the other device via Bluetooth, the notification signal includes an advertising packet, and information on the second time is stored in a data field of a payload of a PDU of the advertising packet.

13. An electronic timepiece comprising a device of claim 1.

14. A time correcting method performed by a device capable of wireless communication and having a time counting function comprising:
counting time of the device;
sending a notification signal for notification of existence of the device when the time of the device reaches a predetermined first time; and
correcting the time of the device to a predetermined second time upon receiving a connection request transmitted from other device in response to the notification signal.

15. A non-transitory computer-readable recording medium for recording a computer program comprising a sequence of instructions which, when executed by a computer included in a device capable of wireless communication and having a time counting function, cause the device to perform steps of:
counting time of the device;
sending a notification signal for notification of existence of the device when the time of the device reaches a predetermined first time; and
correcting the time of the device to a predetermined second time upon receiving a connection request transmitted from other device in response to the notification signal.

16. A device capable of wireless communication comprising:
a counter configured to count time; and
a processor configured to perform control to start detecting a notification signal for notification of existence of other device when the time of the counter reaches a predetermined first time, and, after receiving the notification signal, perform control to transmit a connection request to the other device when the time of the counter reaches a predetermined second time.

17. A time correcting method performed by a device capable of wireless communication and having a time counting function comprising:
counting time of the device;
starting detection of a notification signal for notification of existence of other device when the time of the device reaches a predetermined first time; and
transmitting a connection request to the other device when the time of the device reaches a predetermined second time, after receiving the notification signal.

18. A non-transitory computer-readable recording medium for recording a computer program comprising a sequence of instructions which, when executed by a computer included in a device capable of wireless communication and having a time counting function, cause the device to perform steps of:
counting time of the device;
starting detection of a notification signal for notification of existence of other device when the time of the device reaches a predetermined first time; and
transmitting a connection request to the other device when the time of the device reaches a predetermined second time, after receiving the notification signal.
